(19) United States
(12) Patent Application Publication
(10) Pub. No.: US 2026/0177303 A1
(43) Pub. Date: Jun. 25, 2026

(54) HEAT-GENERATING RESIN COMPOSITION AND REFRIGERATOR INCLUDING THE SAME

(71) Applicant: SAMSUNG ELECTRONICS CO., LTD., Suwon-si (KR)

(72) Inventors: Minsu KANG, Suwon-si (KR); Jangwon LEE, Suwon-si (KR); Nohcheol PARK, Suwon-si (KR)

(73) Assignee: SAMSUNG ELECTRONICS CO., LTD., Suwon-si (KR)

(21) Appl. No.: 19/379,171

(22) Filed: Nov. 4, 2025

Related U.S. Application Data
(63) Continuation of application No. PCT/KR2025/016419, filed on Oct. 16, 2025.

(30) Foreign Application Priority Data
Dec. 24, 2024 (KR) 10-2024-0195094

(51) Int. Cl. F25C 1/24; C08K 3/013; C08K 3/04; F25C 1/12; F25C 5/08

(52) U.S. Cl. CPC F25C 1/24; C08K 3/013; C08K 3/041; C08K 3/042; F25C 1/12; F25C 5/08; C08K 2201/011; F25C 2400/10; F25C 2400/14

(57) ABSTRACT

A resin composition may include: 17 to 40 weight % of a carbon filler; and a remainder of an acrylonitrile butadiene styrene resin, wherein, in response to a voltage being applied to the resin composition, heat is generated by an electrical resistance of the resin composition.

### CROSS-REFERENCE TO RELATED APPLICATIONS

This application is a by-pass continuation application of International Application No. PCT/KR2025/016419, filed on Oct. 16, 2025, which is based on and claims priority to Korean Patent Application No. 10-2024-0195094, filed on Dec. 24, 2024, in the Korean Intellectual Property Office, the disclosures of which are incorporated by reference herein their entireties.

### TECHNICAL FIELD

Various embodiments of the disclosure relate to a heat-generating resin composition and a refrigerator including the same.

### BACKGROUND ART

Generally, a refrigerator is a device that cools and stores food using a refrigeration cycle including a compressor, a condenser, an expansion valve, and an evaporator. The refrigerator may include an ice-making assembly positioned inside the storage compartment and configured to produce ice.

The ice-making assembly may include an ice-making tray forming a space where ice is generated, an ejector separating the ice from the ice-making tray, and an ice bucket formed to store the ice separated from the ice-making tray. The ice-making assembly may further include a controller configured to control the overall ice-making process, thereby enabling the ice-making assembly to automatically produce ice and separate the generated ice.

The ice-making tray may include two trays disposed to be coupled to each other. When the two trays are coupled to each other, a space where ice is generated may be formed.

The above-described information may be provided as related art for the purpose of helping understanding of the disclosure. No claim or determination is made as to whether any of the foregoing is applicable as background art in relation to the disclosure.

### DISCLOSURE OF INVENTION

### Solution to Problems

In accordance with the present disclosure a resin composition may include: 17 to 40 weight % of a carbon filler; and a remainder of an acrylonitrile butadiene styrene resin, wherein, in response to a voltage being applied to the resin composition, heat is generated by an electrical resistance of the resin composition.

The carbon filler may include carbon fiber, carbon nano tubes, carbon black, graphene, or a combination thereof.

The carbon filler may have a composition of 85 weight % to 97 weight % of the carbon fiber with respect to a total weight of the carbon filler.

The carbon filler may have a composition of 1 weight % to 5 weight % of the carbon black with respect to a total weight of the carbon filler.

The carbon filler may have a composition of 1 weight % to 5 weight % of the carbon nano tubes with respect to a total weight of the carbon filler.

The carbon filler may have a composition of 1 weight % to 5 weight % of the graphene with respect to a total weight of the carbon filler.

With the voltage repeatedly being applied to, and withdrawn from, the resin composition 200 times or more during respectively corresponding time intervals, a resistance reduction rate of the resin composition may be 1% or less.

The carbon filler may be irregularly arranged in the resin composition without directionality.

In accordance with the present disclosure a refrigerator may include: a main body including a storage compartment; an ice-making assembly inside the storage compartment and configured to make ice from water; and a water supply member configured to supply the water to be made into the ice from an external water source to the ice-making assembly, wherein at least a portion of the ice-making assembly includes a resin composition including: 17 to 40 weight % of a carbon filler, and a remainder of an acrylonitrile butadiene styrene resin, and in response to a voltage being applied to the resin composition, heat is generated by an electrical resistance of the resin composition.

One or more components of the ice-making assembly, that may be configured to directly contact water or ice during operation of the ice-making assembly, may include the resin composition.

The ice-making assembly may include: a first case including a first tray configured to form a first portion of ice made by the ice-making assembly, and a second case that faces the first case, and including a second tray configured to form a second portion of the ice made by the ice-making assembly, and at least one of the first case, the second case, the first tray, and the second tray may include the resin composition.

The at least one of the first case, the second case, the first tray, and the second tray may further include a pair of electrode portions configured to receive power so as to apply the voltage to the resin composition.

The ice-making assembly may include: a cover housing, and an inlet portion including the resin composition, and configured to guide water supplied from the water supply member to an inside of the cover housing.

The inlet portion and a first component of the ice-making assembly may be integrally formed, and the inlet portion and the first component may each include the resin composition.

The inlet portion may include a first electrode portion, the first component may include a second electrode portion, and the first electrode portion and the second electrode portion may be configured to receive power so as to apply the voltage to the resin composition.

The refrigerator may further include: a pair of doors connected to the main body and that are rotatable to open and close to respectively open and close the storage compartment; and a rotating bar coupled to, and rotatable with respect to, one door of the pair of doors, the rotating bar between the pair of doors and configured to prevent cold air leakage from the storage compartment, wherein a portion of the rotating bar may include the resin composition.

The carbon filler may include carbon fiber, carbon nano tubes, carbon black, graphene, or a combination thereof.

The carbon filler may have a composition of 85 weight % to 97 weight % of the carbon fiber with respect to a total weight of the carbon filler.

The carbon filler may have a composition including: 1 weight % to 5 weight % of the carbon black with respect to a total weight of the carbon filler, 1 weight % to 5 weight % of the carbon nano tubes with respect to the total weight of the carbon filler, and 1 weight % to 5 weight % of the graphene with respect to the total weight of the carbon filler.

The carbon filler may be irregularly arranged in the resin composition without directionality.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF DRAWINGS

FIG. 1 is a view illustrating a refrigerator among home appliances according to an embodiment.

FIG. 2 is an enlarged view illustrating a portion of a refrigerator according to an embodiment.

FIG. 3 illustrates an ice-making assembly included in a refrigerator according to an embodiment.

FIG. 4 is an exploded perspective view illustrating an ice-making assembly according to an embodiment.

FIG. 5 is a flowchart for describing a process of manufacturing a heat-generating injection-molded product using a heat-generating resin composition according to an embodiment.

FIG. 6 is an experimental example measuring resistance change rates according to differences in base resin in a heat-generating resin composition according to an embodiment.

FIG. 7 is an image capturing arrangement changes of carbon filler before and after voltage application when a base resin is polyamide (PA) in a heat-generating resin composition according to an embodiment.

FIG. 8 is an image capturing arrangement changes of carbon filler before and after voltage application when a base resin is acrylonitrile butadiene styrene (ABS) in a heat-generating resin composition according to an embodiment.

FIG. 9 is a perspective view illustrating an inlet portion in an ice-making assembly of a refrigerator according to an embodiment.

FIG. 10 is a perspective view exemplifying a case where some components (e.g., the first fixing frame) of an ice-making assembly of a refrigerator according to an embodiment are composed of a heat-generating resin composition.

FIG. 11 is a perspective view exemplifying a case where an inlet portion and some components of an ice-making assembly of a refrigerator according to an embodiment are integrally formed and composed of a heat-generating resin composition.

FIG. 12 is a plan view illustrating a first tray of an ice-making assembly of a refrigerator according to an embodiment.

FIG. 13 is an exploded perspective view illustrating a rotating bar of a refrigerator according to an embodiment.

Reference may be made to the accompanying drawings in the following description, and specific examples that may be practiced are shown as examples within the drawings. Other examples may be utilized and structural changes may be made without departing from the scope of the various examples.

### MODE FOR THE INVENTION

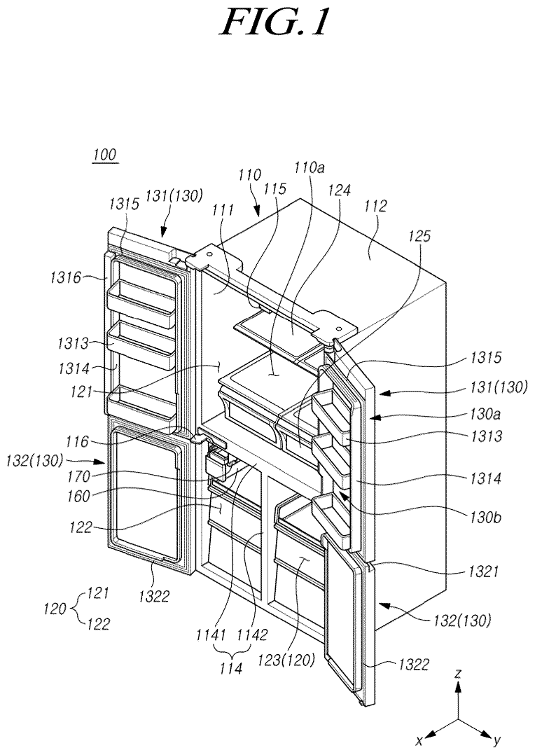

Various embodiments of the disclosure are merely exemplified herein with reference to FIGS. 1 to 13, to describe the principle of the disclosure, and should not be interpreted as limiting the scope of the disclosure. Those skilled in the art will understand that the principle of the disclosure may be implemented in any appropriately disposed system or device.

It should be appreciated that various embodiments of the disclosure and the terms used therein are not intended to limit the technological features set forth herein to particular embodiments and include various changes, equivalents, or replacements for a corresponding embodiment.

With regard to the description of the drawings, similar reference numerals may be used to refer to similar or related elements.

It is to be understood that a singular form of a noun corresponding to an item may include one or more of the things, unless the relevant context clearly indicates otherwise.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases.

The term “and/or” may denote a combination(s) of a plurality of related components as listed or any of the components.

As used herein, such terms as “1st” and “2nd,” or “first” and “second” may be used to simply distinguish a corresponding component from another, and does not limit the components in other aspect (e.g., importance or order).

As used herein, the terms ‘front side,’ ‘rear side,’ ‘upper side,’ ‘lower side’, ‘lateral side,’ ‘left side,’ ‘right side,’ ‘upper portion,’ and ‘lower portion’ are defined with respect to the drawings, and the shape and position of each component are not limited by the terms.

It will be further understood that the terms “comprise” and/or “have,” as used herein, specify the presence of stated features, integers, steps, operations, elements, and/or components, but do not preclude the presence or addition of one or more other features, integers, steps, operations, elements, components, and/or groups thereof.

It will be understood that when a component is referred to as “connected to,” “coupled to”, “supported on,” or “contacting” another component, the components may be connected to, coupled to, supported on, or contact each other directly or via a third component.

Throughout the specification, when one component is positioned “on” another component, the first component may be positioned directly on the second component, or other component(s) may be positioned between the first and second component.

The refrigerator according to an embodiment may include a main body.

The “main body” may include an inner housing, an outer housing disposed outside the inner housing, and an insulator provided between the inner housing and the outer housing.

The “inner housing” may include at least one of a case, a plate, a panel, and a liner forming a storage compartment. The inner housing may be formed as a single body or may be formed by assembling a plurality of plates. The “outer housing” may form the outer appearance of the main body and may be coupled to an outer side of the inner housing so that the insulator is disposed between the inner housing and the outer housing.

The “insulator” may insulate the inside of the storage compartment and the outside of the storage compartment so that the temperature inside the storage compartment is maintained at a set appropriate temperature without being affected by the environment outside the storage compartment. According to an embodiment, the insulator may include a foam insulator. The foam insulator may be formed by injecting and foaming a urethane foam formed by mixing polyurethane and a foaming agent between the inner housing and the outer housing.

According to an embodiment, the insulator may further include a vacuum insulator in addition to the foam insulator, or the insulator may be composed of only a vacuum insulator instead of the foam insulator. The vacuum insulator may include a core material and an outer cover material that accommodates the core material and seals the inside at a pressure close to vacuum or vacuum. However, the insulator is not limited to the foam insulator or the vacuum insulator, and may include various materials that may be used for insulation.

The “storage compartment” may include a space limited by the inner housing. The storage compartment may further include an inner housing that limits a space corresponding to the storage compartment. Various items such as food, medicine, cosmetics, etc. may be stored in the storage compartment, and the storage compartment may be formed so that at least one side thereof is opened to take in and out the items.

The refrigerator may include one or more storage compartments. When two or more storage compartments are formed in the refrigerator, each storage compartment may have a different use and may be maintained at a different temperature. To that end, each storage compartment may be partitioned from each other by a partition wall including an insulator.

The storage compartment may be provided to be maintained in an appropriate temperature range according to the use, and may include a “refrigerating compartment”, a “freezing compartment”, or an “adjustable-temperature compartment” divided by the use and/or temperature range thereof. The refrigerating compartment may be maintained at a temperature suitable for refrigerating and storing items, and the freezing compartment may be maintained at a temperature suitable for freezing and storing items. The term “refrigerating” may mean cooling the item to the extent that the item is not frozen, and for example, the refrigerating compartment may be maintained in the range of 0 degrees Celsius to 7 degrees Celsius. The term “freezing” may mean cooling the item to freeze or remain frozen, and for example, the freezing compartment may be maintained in the range of minus 20 degrees Celsius to minus 1 degree Celsius. The adjustable-temperature compartment may be used as any one of the refrigerating compartment or the freezing compartment regardless of the user's selection.

The storage compartment may be referred to as a “vegetable compartment”, a “fresh compartment”, a “cooling compartment”, an “ice-making compartment”, and the like, in addition to the names “refrigerating compartment”, “freezing compartment”, and “adjustable-temperature compartment”, and the terms “refrigerating compartment”, “freezing compartment”, and “adjustable-temperature compartment” used below should be understood to collectively mean storage compartments having their respective corresponding uses and temperature ranges.

According to an embodiment, the refrigerator may include at least one door configured to open and close one open side of the storage compartment. The door may be provided to open and close each of one or more storage compartments, or one door may be provided to open and close a plurality of storage compartments. The door may be rotatably or slidably installed on the front side of the main body.

The “door” may be configured to seal the storage compartment with the door closed. Like the main body, the door may include an insulator to insulate the storage compartment when the door is closed.

According to an embodiment, the door may include a door outer plate forming a front side of the door, a door inner plate forming a rear side of the door and facing the storage compartment, an upper cap, a lower cap, and a door insulator provided thereinside.

A gasket may be provided on the edge of the door inner plate to seal the storage compartment by being in close contact with the front side of the main body with the door closed. The door inner plate may include a dyke protruding rearward to mount a door basket capable of storing an object.

According to an embodiment, the door may include a door body and a front panel detachably coupled to a front side of the door body and forming a front side of the door. The door body may include a door outer plate forming a front side of the door body, a door inner plate forming a rear side of the door body and facing the storage compartment, an upper cap, a lower cap, and a door insulator provided thereinside.

The refrigerator may be classified into a French door type, a side-by-side type, a bottom mounted freezer (BMF), a top mounted freezer (TMF), or a one-door refrigerator according to the arrangement of the door and the storage compartment.

According to an embodiment, the refrigerator may include a cold air supply device configured to supply cold air to the storage compartment.

The “cold air supply device” may include a machine, an instrument, an electronic device, and/or a system combining the machine, the instrument, and the electronic device capable of generating cold air and guiding the cold air to cool the storage compartment.

According to an embodiment, the cold air supply device may generate cold air through a refrigerating cycle including processes of compressing, condensing, expanding, and evaporating the refrigerant. To that end, the cold air supply device may include a refrigerating cycle device having a compressor, a condenser, an expansion device, and an evaporator capable of driving the refrigerating cycle. According to an embodiment, the cold air supply device may include a semiconductor such as a thermoelectric element. The thermoelectric element may cool the storage compartment by heating and cooling through the Peltier effect.

According to an embodiment, the refrigerator may include a machine room in which at least some components belonging to the cold air supply device are arranged.

The “machine room” may be provided to be partitioned and insulated from the storage compartment to prevent heat generated from components disposed in the machine room from being transferred to the storage compartment. The inside of the machine room may be configured to communicate with the outside of the main body to dissipate heat from components disposed inside the machine room.

According to an embodiment, the refrigerator may include a dispenser provided on the door to provide water and/or ice. The dispenser may be provided on the door to be accessed by the user without opening the door.

According to an embodiment, the refrigerator may include an ice maker provided to generate ice. The ice maker may include an ice-making tray storing water, an ice maker separating ice from the ice-making tray, and an ice bucket storing ice generated in the ice-making tray.

According to an embodiment, the refrigerator may include a controller for controlling the refrigerator.

The “controller” may include a memory storing or recording a program and/or data for controlling the refrigerator, and a processor outputting a control signal for controlling the cold air supply device according to the program and/or data stored in the memory.

The memory stores or records various information, data, instructions, programs, etc. necessary for the operation of the refrigerator. The memory may store temporary data generated while generating a control signal for controlling components included in the refrigerator. The memory may include at least one of a volatile memory and a non-volatile memory or a combination thereof.

The processor controls the overall operation of the refrigerator. The processor may control the components of the refrigerator by executing a program stored in the memory. The processor may include a separate NPU that performs the operation of the artificial intelligence model. The processor may include a central processing unit, a graphics-only processor (GPU), and the like. The processor may generate a control signal for controlling the operation of the cold air supply device. For example, the processor may receive temperature information about the storage compartment from the temperature sensor, and generate a cooling control signal for controlling the operation of the cold air supply device based on the temperature information about the storage compartment.

Further, the processor may process the user input of the user interface according to the program and/or data stored/stored in the memory, and control the operation of the user interface. The user interface may be provided using an input interface and an output interface. The processor may receive a user input from the user interface. Further, the processor may transfer a display control signal and image data for displaying an image on the user interface to the user interface in response to the user input.

The processor and the memory may be provided integrally or separately. The processor may include one or more processors. For example, the processor may include a main processor and at least one sub-processor. The memory may include one or more memories.

The refrigerator may include a processor and a memory controlling all components included in the refrigerator, and a plurality of processors and a plurality of memories individually controlling the components of the refrigerator. For example, the refrigerator may include a processor and a memory controlling the operation of the cold air supply device according to the output of the temperature sensor. Further, the refrigerator may include a separate processor and a separate memory controlling the operation of the user interface according to a user input.

The communication module may communicate with an external device such as a server, a mobile device, another home appliance, or the like through an access point (AP). The AP may connect the local area network (LAN) to which the refrigerator or the user equipment is connected to the wide area network (WAN) to which the server is connected. The refrigerator or the user device may be connected to the server through the wide area network (WAN).

The input interface may include a key, a touch screen, a microphone, and the like. The input interface may receive a user input and transfer the user input to the processor.

The output interface may include a display, a speaker, and the like. The output interface may output various notifications, messages, information, and the like generated by the processor.

FIG. 1 is a view illustrating a refrigerator among home appliances according to an embodiment.

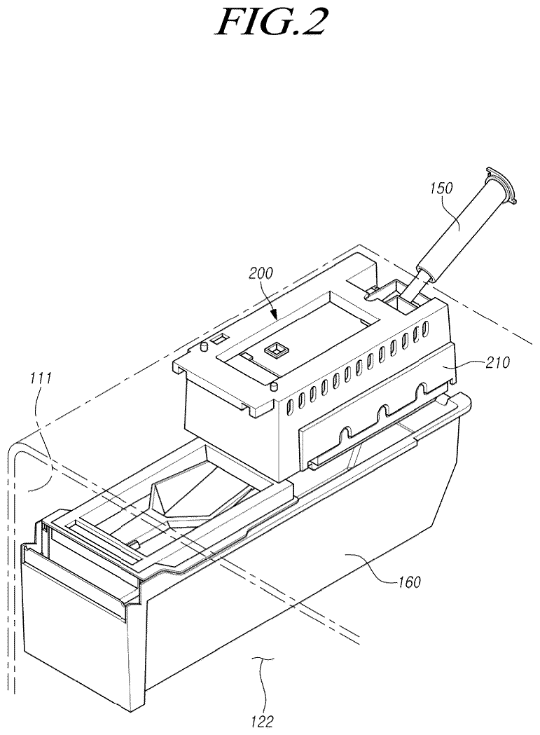

FIG. 2 is an enlarged view illustrating a portion of a refrigerator according to an embodiment.

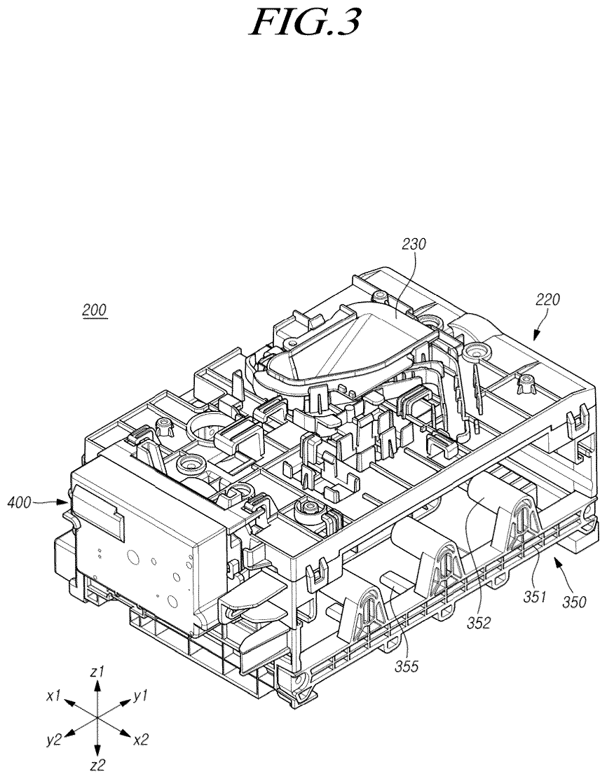

All features, components, and/or arrangement relationships between components illustrated in FIGS. 1 and 2 may be included alone or in combination with the features, components, and arrangement relationships between components described in other drawings of the disclosure. Likewise, all features, components, and/or arrangement relationships between components described in connection with FIGS. 3 to 13 may be included alone or in combination with the features, components, and arrangement relationships between components described in connection with FIGS. 1 and 2.

The refrigerator 100 illustrated in FIG. 1 is a refrigerator illustrated for convenience of description, and the scope of rights of the disclosure is not limited by the configuration and shape of the illustrated refrigerator.

Referring to FIGS. 1 and 2, a refrigerator 100 may include a main body 110, a storage compartment 120, a door 130, or a cold air supply device. The refrigerator 100 of FIG. 1 is illustrated for convenience of description, and the scope of rights of the disclosure is not limited to the shape of the illustrated refrigerator 100.

The storage compartment 120 may be partitioned into several spaces inside the main body 110. The door 130 may be disposed, e.g., on the front side of the main body 110 to open and close the storage compartment 120. The cold air supply device may be provided inside the main body 110 to supply cold air to, e.g., the storage compartment 120.

According to an embodiment, the main body 110 may include an inner housing 111 or an outer housing 112. The inner housing 111, e.g., may form an exterior of the storage compartment 120. The inner housing 111 may be integrally injection-molded with, e.g., a plastic material. The outer housing 112, e.g., may form at least a portion of the exterior of the refrigerator 100. The outer housing 112 may be formed of, e.g., a metal material having excellent durability and aesthetics. A receiving space may be formed between the outer housing 112 and the inner housing 111. A main body insulator (not illustrated) for insulating the storage compartment 120 may be included in a portion of the receiving space.

According to an embodiment, the cold air supply device may generate cold air using a cooling circulation cycle for compressing, condensing, expanding, and evaporating the refrigerant. A cold air supply device may be referred to as, e.g., a heat pump.

According to an embodiment, the main body 110 may form the storage compartment 120. According to an embodiment, the storage compartment 120 may be partitioned into a plurality of compartments by a partition wall 114. In other words, the storage compartment 120 may be formed by the inner housing 111 and the partition wall 114 of the main body 110. A plurality of shelves 124 or storage containers 125 may be disposed inside the storage compartment 120 to store food or the like. The plurality of shelves 124 and the storage container 125 may be disposed to be, e.g., removable.

According to an embodiment, the storage compartment 120 may be divided into a plurality of storage compartments 121, 122, and 123 by the partition wall 114. For example, as illustrated, the storage compartment 120 may include one first storage compartment 121 (e.g., an upper storage compartment) positioned at an upper portion, and a second storage compartments 122 (e.g., a lower storage compartment) and a third storage compartment 123 (e.g., a lower storage compartment) positioned at a lower portion. A first storage compartment 121 may be, e.g., a refrigerating compartment. A second storage compartment 122 and a third storage compartment 123 may be, e.g., freezing compartments.

According to an embodiment, the partition wall 114 may include a first partition wall 1141 and a second partition wall 1142. The partition wall 114 may have, e.g., a T-shaped cross section. The first partition wall 1141 may be disposed horizontally to divide, e.g., the first storage compartment 121 and the second and third storage compartments 122 and 123. The second partition wall 1142 may be disposed vertically to divide, e.g., the second storage compartment 122 and the third storage compartment 123. The second partition wall 1142 may be formed to protrude downward from, e.g., the first partition wall 1141. The illustrated second partition wall 1142 is formed to protrude from the center of the first partition wall 1141, but the disclosure is not limited thereto, and the sizes of the second storage compartment 122 and the third storage compartment 123 may vary depending on the position of the second partition wall 1142. A first partition wall 1141 and a second partition wall 1142 may be integrally formed.

The first storage compartment 121 of the illustrated storage compartment 120 may be used as a refrigerating compartment, and the second and third storage compartments 122 and 123 may be used as freezing compartments, but the disclosure is not limited thereto, and the position and number of each of the refrigerating compartment and the freezing compartment may vary depending on the user's needs.

Further, the number, size, or shape of the storage compartment 120 may vary depending on the shape or position of the partition wall 114. The freezing compartment may be maintained at about minus 20 degrees Celsius, and the refrigerating compartment may be maintained at about 3 degrees Celsius. The storage compartment 120 may be insulated by, e.g., a partition wall 114.

According to an embodiment, the storage compartment 120 may be partitioned left and right by one vertical partition wall. Here, the vertical partition wall may be formed so that one end is in contact with the upper portion of the inner housing 111 and the other end is in contact with the lower portion of the inner housing 111. The size of the storage compartment 120 partitioned left and right may vary depending on the position of the vertical partition wall. For example, the storage compartment 120 having the vertical partition wall provided in the middle and partitioned left and right may be provided in mirror symmetry. According to an embodiment, there may be a plurality of vertical partition walls. When there are a plurality of vertical partition walls, three or more storage compartments 120 may be formed in the left-right direction.

According to an embodiment, the storage compartment 120 may be partitioned up and down only by one horizontal partition wall. In other words, the storage compartment 120 may be partitioned into two, e.g., the upper storage compartment and the lower storage compartment. Here, the horizontal partition wall may be formed so that one end thereof is in contact with the left portion of the inner housing 111 and the other end thereof is in contact with the right portion of the inner housing 111. The size of the storage compartment 120 partitioned up and down may vary depending on the position of the horizontal partition wall. According to an embodiment, there may be a plurality of horizontal partition walls. When there are a plurality of horizontal partition walls, three or more storage compartments 120 may be formed in the up-down direction.

In addition to the above-described embodiment, a plurality of storage compartments 120 of various types may be configured according to the shape and number of partition walls 114.

According to an embodiment, the door 130 may include a first door 131 (e.g., an upper door) or a second door 132 (e.g., a lower door) as illustrated. The door 130 may be formed to open and close, e.g., the opening 110a of the main body 110. For example, a pair of first doors 131 (e.g., double door type) may be configured to open and close the first storage compartment 121. A pair of second doors 132 (e.g., double door type) may be configured to open or close, e.g., the second storage compartment 122 or the third storage compartment 123. Further, the number and shape of the doors 130 may vary depending on the number and shape of the storage compartment 120, and the door 130 may be configured in a sliding manner as well as a manner of rotating about the hinge 116.

According to an embodiment, a rotating bar 1316 may be provided on one of the pair of first doors 131. The rotating bar 1316 may be disposed, e.g., on a side opposite to a side of one of the pair of first doors 131 forming a rotation shaft. The rotating bar 1316 may be disposed such that, e.g., a rotation shaft is fixed to a lateral side of one of the pair of first doors 131 to be rotatable about the rotation shaft. The rotating bar 1316 may be provided to be positioned in the middle of the front side of the main body 110 when one of the pair of first doors 131 is in a closed state. The rotating bar 1316 may seal a gap between the pair of first doors 131 when the pair of first doors 131 are closed. The main body 110 may be provided with a rotating bar guide 115 for guiding the movement of the rotating bar 1316 when one of the pair of first doors 131 is closed.

According to an embodiment, the door 130 (e.g., the first door 131 or the second door 132) may include a door panel 130a or a door body 130b. The door panel 130a and the door body 130b may be detachably coupled to each other.

For example, one side of the door body 130b may be fixed to the main body 110 by a hinge 116. Accordingly, the door body 130b may be disposed to be rotatable about the main body 110. The door panel 130a may form, e.g., a portion of the front exterior of the refrigerator 100. The door panel 130a may play an important role for aesthetics, especially when the refrigerator 100 is disposed indoors. Accordingly, the user may decorate the front exterior of the refrigerator 100 as desired by replacing it with a door panel 130a having a different color or design. According to an embodiment, the door panel 130a and the door body 130b may be integrally formed with each other.

Hereinafter, for convenience of description, only one first door 131 and one second door 132 are described, and a description of the remaining first door 131 and the remaining second door 132 is omitted. However, the first door 131 and the second door 132, which are not described, may be substantially the same as the first door 131 and the second door 132, which are described below, except that they are provided to be symmetrical to each other. Further, the same configuration as that of the first door 131 may be applied to the second door 132, and a detailed description thereof may be omitted.

According to an embodiment, the first door 131 may include a first door handle (not shown), a first door shelf 1313, a first shelf support 1314, or a first gasket 1315. The first door 131 may be rotatably coupled to the main body 110 to open and close at least a portion of the first storage compartment 121. The user may open and close the first door 131 using the first door handle. The first door handle may be recessed in the bottom side of the first door 131 or may protrude from the front side of the first door 131, but the disclosure is not limited thereto.

The first door shelf 1313 may be disposed to receive, e.g., food. First shelf supports 1314 may be disposed on both left and right sides of the first door shelf 1313 to support the first door shelf 1313. The first shelf support 1314 may extend vertically from, e.g., the first door 131. In other words, the first shelf support 1314 may be disposed to protrude backward from the rear side of the first door 131 and extend in the up-down direction. For example, the first shelf support 1314 may be detachably disposed on the first door 131 as a separate component, or may be integrally formed with the first door 31. The first shelf support 1314 may be formed to protrude rearward from, e.g., the rear side of the door body 130b.

The first gasket 1315 may be provided to surround, e.g., a rear edge of the first door 131. Specifically, the first gasket 1315 may be provided to surround an edge of the door body 130b. The first gasket 1315 may be provided to seal a gap with the main body 110 in a state in which the first door 131 is closed.

According to an embodiment, the second door 132 may include a second door handle 1321 or a second gasket 1322. The second door 132 may be disposed to be rotatably coupled to the main body 110 to open and close the second storage compartment 122 or the third storage compartment 123. The user may open and close the second door 132 using the second door handle 1321. The second door handle 1321 may be recessed in the upper side of the second door 132 or may protrude from the front side of the second door 132, but the disclosure is not limited thereto.

The second gasket 1322 may be disposed to surround, e.g., a rear edge of the second door 132. The second gasket 1322 may be disposed to seal a gap with the main body 110 in a state in which the second door 132 is closed.

Although not illustrated, the second door 132 may further include all or some of the same components as the first door shelf 1313 and the first shelf support 1314 of the first door 131.

According to an embodiment, the refrigerator 100 may further include an ice-making assembly 200. According to an embodiment, the ice-making assembly 200 for generating ice using the cold air of the second storage compartment 122 may be disposed on one side of the second storage compartment 122 (e.g., freezing compartment). Further, an ice bucket 160 provided to store ice generated from the ice-making assembly 200 may be mounted on the mounting frame 170.

According to an embodiment, the ice-making assembly 200 may generate ball-shaped ice. However, without limitations thereto, various shapes of ice may be generated corresponding to the shape of the space formed by the trays (e.g., the first tray 270 and the second tray 370 of FIG. 3) included in the ice-making assembly 200.

According to an embodiment, the refrigerator 100 may further include a water supply member 150. The water supply member 150 may be formed to receive and deliver water from an external water source. For example, the water supply member 150 may be formed to receive water from the outside and deliver it into the ice-making assembly 200. The water supply member 150 may communicate with the storage compartment 120 by passing through the inner housing 111 of the refrigerator 100. To this end, a portion of the water supply member 150 may be embedded in insulation, and one end of the water supply member 150 may be disposed to be exposed to the storage compartment 120 of the refrigerator 100.

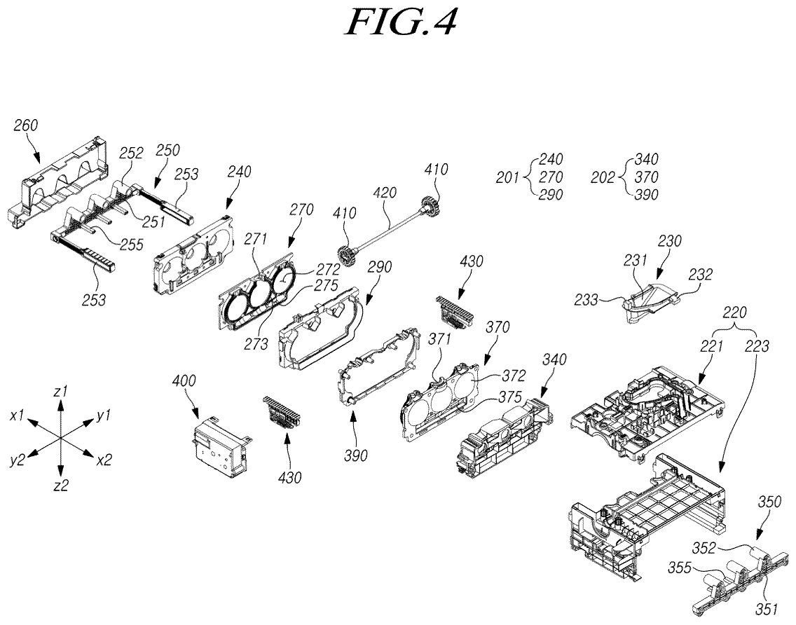

According to an embodiment, when the ice-making assembly 200 generates ice, to enhance the transparency of the ice and to generate the shape of the ice closer to a spherical shape, the ice-making assembly 200 of the disclosure may include buffer cells (e.g., the first buffer cell 275 and the second buffer cell 375 of FIG. 4) formed in the first tray 270 and the second tray 370. The buffer cells 275 may be positioned under the ice-making cells (e.g., the first ice-making cell 272 and the second ice-making cell 372 of FIG. 4) formed to produce ball ice. The buffer cells 275, 375 may form a space where water supplied from the water supply member 150 to the ice-making assembly 200 is primarily stored. When water is stored in the buffer cells 275, 375 beyond a predetermined amount, the water may move from the buffer cells 275, 375 to the ice-making cells 272, 372.

According to an embodiment, in a process of generating ice in the ice-making assembly 200, the ice-making assembly 200 may have a heat generation function to easily release ice formed in the first tray 270 and the second tray 370 and to easily remove remaining ice pieces (hereinafter referred to as residual ice) left in the first tray 270 and the second tray 370.

According to an embodiment, some of the components injection-molded in the refrigerator 100 may be composed of injection-molded products that generate heat by power application. The heat-generating injection-molded products may include a heat-generating resin composition to be described below. For example, by manufacturing injection-molded products around portions where heating devices (or heaters) are disposed among the components of the refrigerator 100 using a heat-generating resin composition, heaters may be omitted to reduce manufacturing costs. Further, in the process of assembling heaters, workers directly assemble them, and the assembly state differs according to the worker's skill level, and defective assembly sometimes occurs. However, in the disclosure, by omitting heaters and using injection-molded products using a heat-generating resin composition, defect rates may be minimized in the manufacturing process. Further, as is described below, even when power is repeatedly applied to injection-molded products using a heat-generating resin composition according to an embodiment, the resistance change rate is very low, providing high durability.

FIG. 3 illustrates an ice-making assembly included in a refrigerator according to an embodiment.

FIG. 4 is an exploded perspective view illustrating an ice-making assembly according to an embodiment.

All features, components, and/or arrangement relationships between components illustrated in FIGS. 3 and 4 may be included alone or in combination with the features, components, and arrangement relationships between components described in other drawings of the disclosure. Likewise, all features, components, and/or arrangement relationships between components described in connection with FIGS. 1 and 2 and 5 to 13 may be included alone or in combination with the features, components, and arrangement relationships between components described in connection with FIGS. 3 and 4.

Referring to FIG. 3 and FIG. 4, the ice-making assembly 200 may include a cover housing 220. The cover housing 220 may be provided to be coupled with the ice-making housing (e.g., the ice-making housing 210 of FIG. 2) inside the ice-making housing 210. The cover housing 220 may be provided in a box shape with one side and the bottom open.

According to an embodiment, the cover housing 220 may form the overall exterior of the ice-making assembly 200 and may be disposed to surround the first block 201 and the second block 202. The cover housing 220 may include a main housing 223 and an upper cover 221 disposed on the upper side of the main housing 223.

According to an embodiment, the main housing 223 may form a box-shaped space for receiving the first block 201 and the second block 202. For example, the main housing 223 may be formed so that the front and rear (e.g., x1 or x2 direction) where the first block 201 and the second block 202 move are open, and the lower direction (e.g., z2 direction) for removing the ice produced in the ice-making assembly 200 is open.

According to an embodiment, the ice-making assembly 200 may include an inlet portion 230. The inlet portion 230 may be mounted on one side of the cover housing 220. For example, the inlet portion 230 may be mounted on the upper side of the upper cover 221. The inlet portion 230 may guide water supplied from the water supply member 150 to move inside the cover housing 220. In other words, the inlet portion 230 may be provided to allow water supplied from the water supply member 150 to move inside the space formed by the first tray 270 and the second tray 370.

According to an embodiment, the ice-making assembly 200 may include the cover housing 220 and the first block 201 and the second block 202, which are disposed to be fixed to the cover housing 220 and formed to move mutually. The ice-making assembly 200 may further include a first pressing unit 250 configured to press the first block 201 and a second pressing unit 350 configured to press the second block 202.

According to an embodiment, the first block 201 may include a first case 240, a first tray 270 disposed to be received in the first case 240, and a first fixing frame 290 formed to fix the first case 240 and the first tray 270.

According to an embodiment, the second block 202 may include a second case 340, a second tray 370 disposed to be received in the second case 340, and a second fixing frame 390 formed to fix the second case 340 and the second tray 370.

According to an embodiment, the ice-making assembly 200 may form an ice-making space for forming ice by mutual movement of a first block 201 and a second block 202 disposed to face each other. For example, as the first block 201 and the second block 202 tightly contact each other, an ice-making space for forming ball ice may be formed.

According to an embodiment, the ice-making assembly 200 may be formed so that the first block 201 and the second block 202 move away from each other to take out the produced ice and store it in an ice bucket 160. For example, while the first block 201 and the second block 202 are separated and move away from each other, the first pressing unit 250 and the second pressing unit 350 may press the first tray 270 and the second tray 370, respectively, to remove the ice (e.g., ball ice and buffer ice) formed in the ice-making space.

According to an embodiment, the first case 240 may be disposed on one side of the cover housing 220. For example, the first case 240 may be integrally formed with the cover housing 220 or may be separately configured to be disposed to be coupled to one side of the cover housing 220.

According to an embodiment, the first pressing unit 250 may be formed to press the first tray 270. For example, the first pressing unit 250 may press the first tray 270 to remove ice.

According to an embodiment, the first pressing unit 250 may include a body 251, a first ejecting pin 252, and a second ejecting pin 255, which are formed to protrude toward

the first tray 270 (e.g., in the x2 direction) from the body 251. For example, the first ejecting pin 252 may be formed to press the first ice-making cell 272. For example, the second ejecting pin 255 may be formed to press the first buffer cell 275.

According to an embodiment, the first pressing unit 250 may further include legs 253. The legs 253 may be disposed on two opposite sides of the body 251. For example, the legs 253 may be disposed parallel to the moving direction of the first pressing unit 250 (e.g., in the x1 or x2 direction). The legs 253 may be disposed on two opposite sides of the cover housing 220 and may be connected to one side of the second case 340.

According to an embodiment, the first tray 270 may be disposed inside the ice-making housing 210. For example, the first tray 270 may be mounted inside the cover housing 220.

According to an embodiment, the first tray 270 may be formed of a material having elasticity. For example, the first tray 270 may be composed of a material including at least one of silicone, synthetic rubber, and urethane.

According to an embodiment, the first tray 270 may receive water from the water supply member 150. The first tray 270 may include a guide portion 271 to guide the water supplied from the water supply member 150 into the ice-making cell inside the first tray 270 through the inlet portion 230. The guide portion 271 may be formed on the upper side of the first tray 270.

According to an embodiment, the first tray 270 may include a first ice-making cell (ice cell) 272 provided to form a portion of the ice. The first ice-making cell 272 may be formed by recessing or removing a portion of the first tray 270. For example, the first ice-making cell 272 may be provided in a substantially hemispherical shape. Although three first ice-making cells 272 are illustrated and described, it is not limited to the illustrated number, and the number of the first ice-making cells 272 is not limited thereto.

According to an embodiment, the first tray 270 may include a first buffer cell 275. The first buffer cell 275 may be disposed under the first ice-making cell 272. The first buffer cell 275 may be connected by a first bridge 273 with the first ice-making cell 272. By being connected by the first bridge 273, the first ice-making cell 272 and the first buffer cell 275 allow the water supplied from the water supply member 150 to move from the first buffer cell 275 toward the first ice-making cell 272.

According to an embodiment, a first fixing frame 290 may be formed to couple the first tray 270 with the first case 240. For example, the first fixing frame 290 may be fixed to one side of the cover housing 220 in a state in which the first tray 270 and the first case 240 are coupled.

According to an embodiment, the first fixing frame 290 may be formed to support the edge of the first tray 270. The first fixing frame 290 may reinforce the insufficient rigidity of the first tray 270 as the material of the first tray 270 is composed of an elastic material.

According to an embodiment, the second block 202 may be provided to be movable in the cover housing 220.

According to an embodiment, the second block 202 may include a second case 340, a second tray 370 disposed to be received in the second case 340, a second pressing unit 350 formed to press the second tray 370, and a second fixing frame 390 formed to fix the second case 340 and the second tray 370.

According to an embodiment, the components (e.g., the second case 340, the second tray 370, the second pressing unit 350, and the second fixing frame 390) included in the second block 202 may respectively correspond to the components included in the first block 201. For example, the second case 340 may correspond to the first case 240. For example, the second tray 370 may correspond to the first tray 270. For example, the second pressing unit 350 may correspond to the first pressing unit 250. For example, the second fixing frame 390 may correspond to the first fixing frame 290. Each component included in the second block 202 may be substantially the same in shape and function as each component included in the first block 201. Therefore, the description of each component included in the first block 201 may be applied to each component included in the second block 202.

According to an embodiment, the second case 340 may be formed on one side of the cover housing 220. For example, the second case 340 may be integrally formed with the cover housing 220, or may be separately configured and disposed to be coupled to one side of the cover housing 220.

According to an embodiment, the second case 340 may receive the second tray 370. For example, the second case 340 may include a second tray receiving portion formed to receive the second tray 370.

According to an embodiment, the second pressing unit 350 may be formed to press the second tray 370. For example, the second pressing unit 350 may press the second tray 370 to Remove Ice.

According to an embodiment, the second pressing unit 350 may include a body 351 and a first ejecting pin 352 and a second ejecting pin 355 formed to protrude from the body 351 toward the second tray 370 (e.g., in the x1 direction). For example, the first ejecting pin 352 may be formed to press the second ice cell 372. For example, the second ejecting pin 355 may be formed to press the second buffer cell 375.

According to an embodiment, the second tray 370 may be disposed inside the ice-making housing 210. For example, the second tray 370 may be mounted inside the cover housing 220.

According to an embodiment, the second tray 370 may be formed of a material having elasticity. For example, the second tray 370 may be composed of a material including at least one of silicone, synthetic rubber, and urethane.

According to an embodiment, the second tray 370 may receive water from the water supply member 150. The second tray 370 may include a guide portion 371 to guide the water supplied from the water supply member 150 into the ice-making cell inside the second tray 370 through the inlet portion 230. The guide portion 371 may be formed on the upper side of the second tray 370.

According to an embodiment, the second tray 370 may include a second ice-making cell (ice cell) 372 provided to form a portion of the ice. The second ice cell 372 may be formed by recessing or removing a portion of the second tray 370. For example, the second ice cell 372 may be provided in a substantially hemispherical shape. Although three second ice cells 372 are illustrated and described, it is not limited to the illustrated number, and the number of the second ice cells 372 is not limited thereto.

According to an embodiment, the second tray 370 may include a second buffer cell 375. The second buffer cell 375 may be disposed under the second ice cell 372. The second buffer cell 375 may be connected to the second ice cell 372 by the second bridge. By being connected by the second bridge, the second ice cell 372 and the second buffer cell 375 may allow the water supplied from the water supply member 150 to move from the second buffer cell 375 toward the second ice cell 372.

According to an embodiment, the second fixing frame 390 may be formed to couple the second tray 370 with the second case 340. For example, the second fixing frame 390 may be fixed to one side of the cover housing 220 in a state in which the second tray 370 and the second case 340 are coupled.

According to an embodiment, the second fixing frame 390 may be formed to support the edge of the second tray 370. The second fixing frame 390 may reinforce the insufficient rigidity of the second tray 370 as the material of the second tray 370 is composed of an elastic material.

According to an embodiment, the ice-making assembly 200 may further include a driving unit 400, a pinion 410, a bar 420, a rack gear 430, and an elastic member.

According to an embodiment, the driving unit 400 may be provided to generate power. For example, various electrical components such as a motor and a circuit board may be disposed inside the driving unit 400. For example, the driving unit 400 may be coupled to the cover housing 220.

For example, the pinion 410 may be coupled to the driving unit 400 to transfer power generated from the driving unit 400. For example, a pair of pinions 410 may be provided. The pair of pinions 410 may be connected by the bar 420. For example, the pair of pinions 410 may be respectively connected to two opposite sides of the bar 420. The pinion 410 may be formed to rotate according to the driving of the driving unit 400. For example, the pinion 410 may be provided in a toothed shape to engage with the rack gear 430.

According to an embodiment, the rack gear 430 may be formed to be movable with respect to the cover housing 220. For example, based on the rotational movement of the pinion 410, the rack gear 430 may be moved linearly.

According to an embodiment, the rack gear 430 may include a support portion supported by the cover housing 220 and a toothed portion formed on an upper side of the support portion. For example, by the engagement of the toothed portion of the rack gear 430 and a pinion 410, the rack gear 430 may be configured to move in a horizontal direction (e.g., x1 or x2 direction) relative to the cover housing 220.

According to an embodiment, the pinion 410 and the rack gear 430 may engage to convert rotational movement of the driving unit 300 into linear movement. However, the structure is not limited to the illustrated structure, and various structures capable of converting rotational movement into linear movement may be applied.

According to an embodiment, the elastic member may be configured to connect the rack gear 430 and the second case 340. In other words, the rack gear 430 and the second case 340 may be connected by the elastic member. For example, the elastic member may be implemented as a coil spring but, without limitations thereto, may be implemented as various components providing an elastic force in a predetermined direction.

According to an embodiment, as the rack gear 430 receives power from the driving unit 400 and moves, the second case 340 may move in a horizontal direction (e.g., x1 or x2 direction) relative to the cover housing 220 in conjunction therewith. For example, the second tray 370 and the second case 340 may move linearly relative to the cover housing 220 by the rack gear 430.

According to an embodiment, the second case 340 may be moved together with the second tray 370 and the second fixing frame 390, and the second tray 370 may move horizontally relative to the first tray 270. As a result, the first block 201 and the second block 202 may move relative to each other to either contact or separate during an ice-making process and an ice-releasing process.

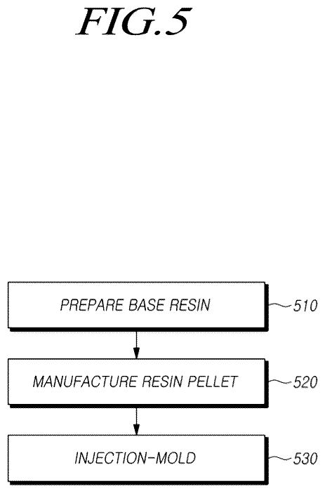

According to an embodiment, at least a portion of the ice-making assembly 200 may be composed of a heat-generating resin composition that generates heat by electrical supply. Some of the components injection-molded in the ice-making assembly 200 may be composed of a heat-generating resin composition that generates heat by electrical supply. Here, the composition of the heat-generating resin composition and a method for manufacturing heat-generating injection-molded products using the same are specifically described with reference to FIGS. 5 to 8.

According to an embodiment, in the ice-making assembly 200, at least some components among components that directly contact water or ice may be composed of a heat-generating resin composition. For example, among the components of the ice-making assembly 200, an inlet portion 230, a first tray 270, and/or a second tray 370 may be composed of injection-molded products that generate heat when power is applied. However, without limitations thereto, components that may indirectly transfer heat to water or ice at positions capable of heating components in contact with water or ice may also be composed of a heat-generating resin composition. Here, the composition of the heat-generating resin composition and a method for manufacturing heat-generating injection-molded products using the same are specifically described with reference to FIGS. 5 to 8.

According to an embodiment, at least one of the first tray 270 and the second tray 370 composed of a heat-generating resin composition may form a pair of electrode portions. Wires are connected to the pair of electrode portions to apply power to at least one of the first tray 270 and the second tray 370.

The ice-making assembly 200 including components injection-molded using a heat-generating resin composition according to an embodiment may reduce manufacturing costs by omitting heaters and generating heat using injection-molded products. Further, as is described below, even when power is repeatedly applied using a heat-generating resin composition according to an embodiment, the resistance change rate is very low, providing high durability.

FIG. 5 is a flowchart for describing a process of manufacturing a heat-generating injection-molded product using a heat-generating resin composition according to an embodiment.

All features, components, and/or arrangement relationships between components illustrated in FIG. 5 may be included alone or in combination with the features, components, and arrangement relationships between components described in other drawings of the disclosure. Likewise, all features, components, and/or arrangement relationships between components described in connection with FIGS. 1 to 4 and 5 to 13 may be included alone or in combination with the features, components, and arrangement relationships between components described in connection with FIG. 5.

Referring to FIG. 5, the process of manufacturing a heat-generating injection-molded product may include a base resin preparation process 510, a resin pellet manufacturing process 520, and an injection molding process 530.

According to an embodiment, in the process 510 of preparing a base resin, the base resin may be an acrylonitrile butadiene styrene (ABS) resin. As a base resin for injection-molded products, polyamide (PA) or polypropylene (PP) may be used in addition to ABS resin, but in the disclosure, injection-molded products may be manufactured using only ABS resin as a base resin.

According to an embodiment, the content of the ABS resin as a base resin may be 70 to 83 weight %.

According to an embodiment, in the process 520 of manufacturing heat-generating resin pellets, carbon filler may be mixed with the base resin. Here, the carbon filler may include at least one of carbon fiber (CF), carbon nano tube (CNT), carbon black (CB), and graphene.

According to an embodiment, the content of the carbon filler may be 17 weight % to 40 weight %. When the content of the carbon filler is less than 17 weight %, it may become difficult to maintain the shape as an injection-molded product. When the content of the carbon filler exceeds 40 weight %, the rigidity of the injection-molded product may be decreased.

According to an embodiment, carbon fiber may be included in an amount of 85% to 97 weight % with respect to 100 weight % of the carbon filler. Carbon black may be included in an amount of 1 weight % to 5 weight % with respect to 100 weight % of the carbon filler. Carbon nano tubes may be included in an amount of 1 weight % to 5 weight % with respect to 100 weight % of the carbon filler. Graphene may be included in an amount of 1 weight % to 5 weight % with respect to 100 weight % of the carbon filler.

According to an embodiment, the manufactured heat-generating resin pellets may be dried at about 80 degrees Celsius for about 2 hours.

According to an embodiment, in the injection molding process 530, heat-generating injection-molded products may be formed using the heat-generating resin pellets. The heat-generating injection-molded products may be, e.g., at least one injection-molded product included in a refrigerator (e.g., the refrigerator 100 of FIG. 1). For example, some components of an ice-making assembly (e.g., the ice-making assembly 200 of FIG. 2) may be injection-molded using the process of FIG. 5.

The heat-generating injection-molded products manufactured through the process of FIG. 5 may be provided to replace portions where heat-generating devices (or heaters) were provided in the refrigerator 100. The heat-generating injection-molded products manufactured through the process of FIG. 5 may be included as a component of the refrigerator, but this is exemplary, and they may be included in various electronic devices or home appliances requiring heat generation other than refrigerators.

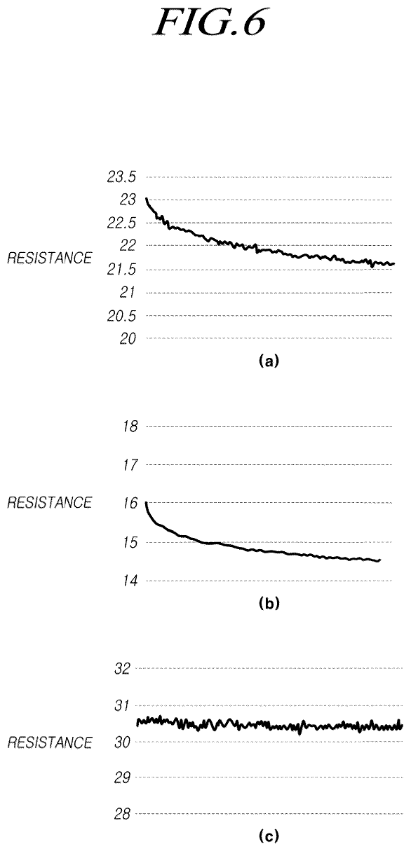

FIG. 6 is an experimental example measuring resistance change rates according to differences in base resin in a heat-generating resin composition according to an embodiment.

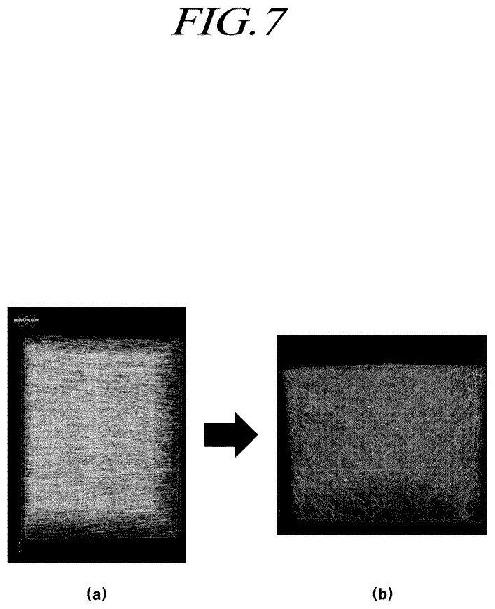

FIG. 7 is an image capturing arrangement changes of carbon filler before and after voltage application when a base resin is polyamide (PA) in a heat-generating resin composition according to an embodiment.

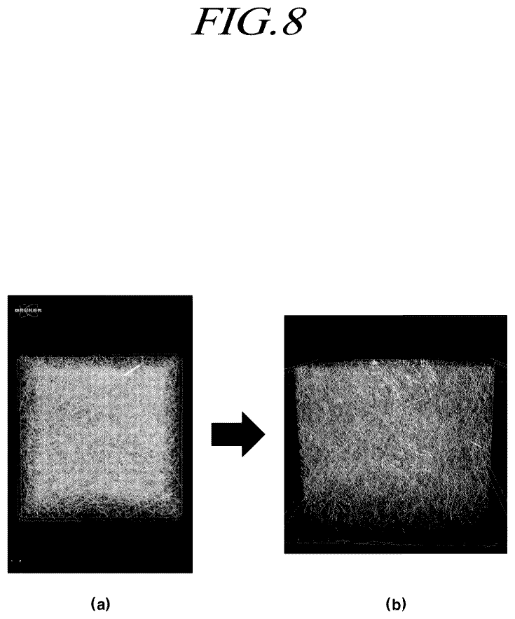

FIG. 8 is an image capturing arrangement changes of carbon filler before and after voltage application when a base resin is acrylonitrile butadiene styrene (ABS) in a heat-generating resin composition according to an embodiment.

All features, components, and/or arrangement relationships between components illustrated in FIGS. 6 to 8 may be included alone or in combination with the features, components, and arrangement relationships between components described in other drawings of the disclosure. Likewise, all features, components, and/or arrangement relationships between components described in connection with FIGS. 1 to 5 and 9 to 13 may be included alone or in combination with the features, components, and arrangement relationships between components described in connection with FIGS. 6 to 8.

As illustrated in FIG. 6, differences in resistance change rates according to usage period may occur depending on the type of base resin. FIG. 6(a) illustrates the resistance change rate of heat-generating injection-molded products manufactured using PP as a base resin, FIG. 6(b) illustrates the resistance change rate of heat-generating injection-molded products manufactured using PA as a base resin, and FIG. 6(c) illustrates the resistance change rate of heat-generating injection-molded products manufactured using ABS as a base resin.

(a), (b), and (c) of FIG. 6 illustrate the resistance change rates measured while repeating 200 times a process of applying 6V voltage for 10 minutes followed by 10 minutes of cooling in a chamber simulating the environment inside a refrigerator (e.g., the refrigerator 100 of FIG. 1) (e.g., minus 25 degrees Celsius).

For heat-generating injection-molded products using PP as a base resin, electrical resistance decreased by about 6.25% during 200 repetitions of voltage application and cooling. For heat-generating injection-molded products using PA as a base resin, electrical resistance decreased by about 8.92% during 200 repetitions of voltage application and cooling. When the magnitude of voltage applied to heat-generating injection-molded products is constant but electrical resistance decreases as usage period passes, power consumption of the refrigerator 100 may increase or damage to the heat-generating injection-molded products may occur.

On the other hand, for heat-generating injection-molded products using ABS as a base resin, electrical resistance decreased by about 0.04% during 200 repetitions of voltage application and cooling. It may be identified through experiments that the electrical resistance change rate is significantly lower than when PP or PA is used as a base resin. Through such experiments, the heat-generating resin composition according to an embodiment of the disclosure used ABS resin as a base resin.

According to an embodiment, a heat-generating resin composition (or heat-generating injection-molded product) using ABS as a base resin may have a resistance reduction rate of 1% or less when voltage application and voltage non-application repetitions are performed 200 times or more at predetermined time intervals.

Referring to FIG. 7, for heat-generating injection-molded products using PA as a base resin, it may be identified that before voltage application, the arrangement of carbon filler is disposed to face generally one direction (or in parallel) overall. In other words, carbon filler may be regularly disposed within heat-generating injection-molded products using PA as a base resin. However, after voltage application, it may be identified that the arrangement of carbon filler changes irregularly. Such arrangement of carbon filler continuously changes according to repetition of voltage application, which may cause changes in electrical resistance.

Referring to FIG. 8, for heat-generating injection-molded products using ABS as a base resin, it may be identified that carbon filler included in the heat-generating resin composition (or heat-generating injection-molded product) before voltage application is irregularly disposed without directionality. Even after voltage application, carbon filler is similarly irregularly disposed. Since there is no significant difference in the directionality of carbon filler before and after voltage application, heat-generating injection-molded products using ABS as a base resin may have high durability even when voltage is continuously applied.

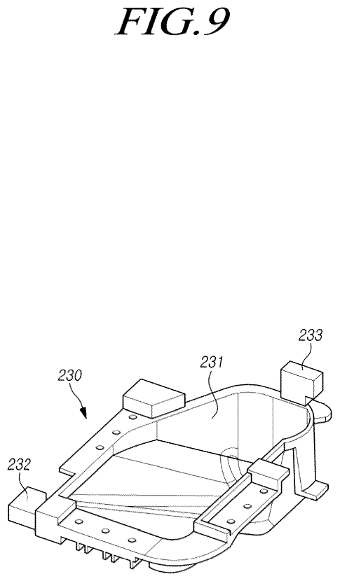

FIG. 9 is a perspective view illustrating an inlet portion in an ice-making assembly of a refrigerator according to an embodiment.

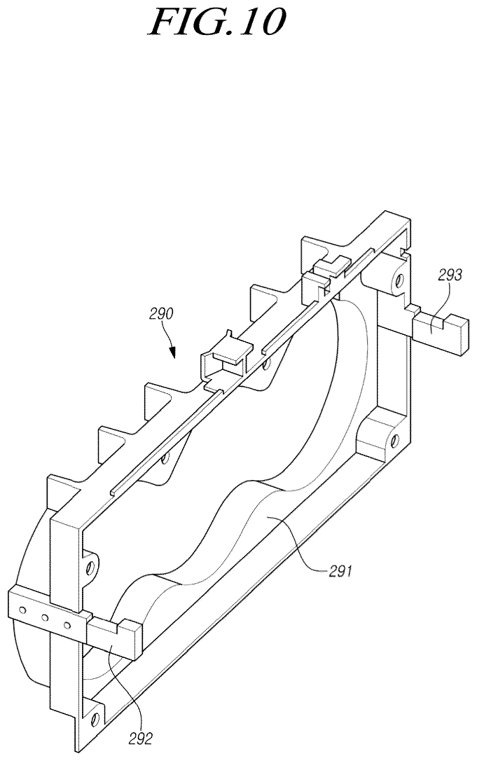

FIG. 10 is a perspective view exemplifying a case where some components (e.g., the first fixing frame) of an ice-making assembly of a refrigerator according to an embodiment are composed of a heat-generating resin composition.

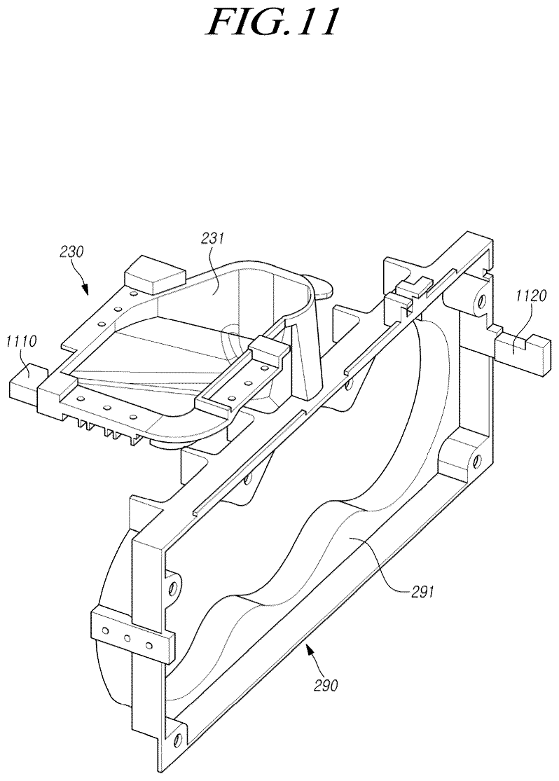

FIG. 11 is a perspective view exemplifying a case where an inlet portion and some components of an ice-making assembly of a refrigerator according to an embodiment are integrally formed and composed of a heat-generating resin composition.

All features, components, and/or arrangement relationships between components illustrated in FIGS. 9 to 11 may be included alone or in combination with the features, components, and arrangement relationships between components described in other drawings of the disclosure. Likewise, all features, components, and/or arrangement relationships between components described in connection with FIGS. 1 to 8 and 12 and 13 may be included alone or in combination with the features, components, and arrangement relationships between components described in connection with FIG. 5.

FIGS. 9 to 11 are drawings for describing injection-molded components using a heat-generating resin composition among the components of the ice-making assembly 200 as examples. Injection-molded products using a heat-generating resin composition in the disclosure are not limited by what is illustrated in FIGS. 9 to 11.

Referring to FIGS. 9, 10, and 11, an ice-making assembly (e.g., the ice-making assembly 200 of FIG. 2) according to an embodiment may include an inlet portion 230 and a first fixing frame 290.

Referring to FIG. 9, according to an embodiment, the inlet portion 230 may be injection-molded using a heat-generating resin composition. Here, the heat-generating resin composition may be manufactured using ABS resin as a base resin.

According to an embodiment, the inlet portion 230 may be configured to guide water transferred from a water supply member (e.g., the water supply member 150 of FIG. 2) to the inside of the ice-making assembly 200. In the case of the inlet portion 230, water remaining on the side may freeze due to exposure to the temperature environment of the refrigerating compartment of a refrigerator (e.g., the refrigerator 100 of FIG. 1). When the inlet portion 230 is injection-molded using a heat-generating resin composition, voltage may be applied to generate heat to control so that water on the surface of the inlet portion 230 does not freeze.

According to an embodiment, the inlet portion 230 may include 17 weight % to 40 weight % of carbon filler and 60 to 83 weight % of acrylonitrile butadiene styrene (ABS) resin. The carbon filler may include at least one of carbon fiber, carbon nano tubes, carbon black, and graphene. The composition included in the heat-generating resin composition may include, with respect to 100 weight % of carbon filler, 85 weight % to 97 weight % of carbon filler, 1 weight % to 5 weight % of carbon black, 1 weight % to 5 weight % of carbon nano tubes, and 1 weight % to 5 weight % of graphene.

According to an embodiment, the inlet portion 230 may include an inlet portion body 231 and a pair of electrode portions 232, 233. The pair of electrode portions 232, 233 may extend from the inlet portion body 231. The pair of electrode portions 232, 233 may extend from edge portions of the inlet portion body 231, but the disclosure is not limited thereto. The inlet portion 230 may generate heat in response to an applied voltage through the pair of electrode portions 232, 233.

Referring to FIG. 10, the first fixing frame 290 according to an embodiment may be injection-molded using a heat-generating resin composition. Here, the heat-generating resin composition may be manufactured using ABS resin as a base resin.

According to an embodiment, the first fixing frame 290 may be heated by voltage application in the process of separating ice formed in a first tray (e.g., the first tray 270 of FIG. 4) and a second tray (e.g., the second tray 370 of FIG. 4) from the first tray 270 and the second tray 370. By increasing the temperature of the first fixing frame 290, ice may be easily separated from the first tray 270 and the second tray 370.

According to an embodiment, the first fixing frame 290 may include 17 weight % to 40 weight % of carbon filler and 60 to 83 weight % of acrylonitrile butadiene styrene (ABS) resin. The carbon filler may include at least one of carbon fiber, carbon nano tubes, carbon black, and graphene. The composition included in the heat-generating resin composition may include, with respect to 100 weight % of carbon filler, 85 weight % to 97 weight % of carbon filler, 1 weight % to 5 weight % of carbon black, 1 weight % to 5 weight % of carbon nano tubes, and 1 weight % to 5 weight % of graphene.

According to an embodiment, the first fixing frame 290 may include a frame body 291 and a pair of electrode portions 292, 293. The pair of electrode portions 292, 293 may extend from the frame body 291. The pair of electrode portions 292, 293 may extend from edge portions of the frame body 291, but the disclosure is not limited thereto. The first fixing frame 290 may generate heat in response to an applied voltage through the pair of electrode portions 292, 293.

Although FIG. 10 illustrates the first fixing frame 290 as an example, it is not limited thereto, and a second fixing frame 390 may likewise be injection-molded using a heat-generating resin composition.

Referring to FIG. 11, according to an embodiment, the inlet portion 230 and a first component of the ice-making assembly 200 may be integrally formed. The inlet portion 230 and the first component integrally formed may be composed of a heat-generating resin composition. In FIG. 11, the first component is illustrated as the first fixing frame 290 as an example, but the first component is not limited thereto and may be a component that may be integrally formed in contact with the inlet portion 230. Hereinafter, for convenience of description, the first component is described using the first fixing frame 290 as an example.

According to an embodiment, the integrally formed inlet portion 230 and first fixing frame 290 may be injection-molded using a heat-generating resin composition. Here, the heat-generating resin composition may be manufactured using ABS resin as a base resin.

According to an embodiment, the inlet portion 230 may include a first electrode portion 1110. The first electrode portion 1110 may extend from the inlet portion body 231. The first electrode portion 1110 may be disposed at an edge of the inlet portion body 231.

According to an embodiment, the first fixing frame 290 may include a second electrode portion 1120. The second electrode portion 1120 may extend from the frame body 291. The second electrode portion 1120 may be disposed at an edge of the frame body 291.

When heat-generating injection-molded products are integrally formed as illustrated in FIG. 11, the number of electrode portions for applying power may be decreased, making the manufacturing and assembly processes less difficult.

According to an embodiment, the ‘heat-generating resin composition’ mentioned in FIGS. 9 to 11 may be substantially the same as the heat-generating resin composition described with reference to FIGS. 5 to 8. The composition of the ‘heat-generating resin composition’ in FIGS. 9 to 11 may be substantially the same as the composition of the heat-generating resin composition described with reference to FIGS. 5 to 8.

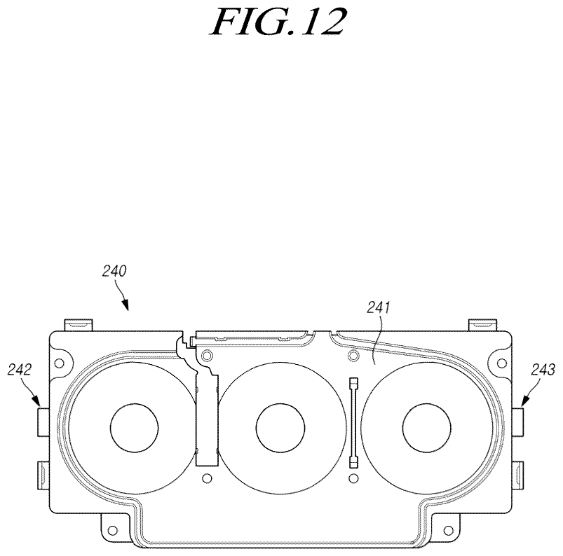

FIG. 12 is a plan view illustrating a first tray of an ice-making assembly of a refrigerator according to an embodiment.

All features, components, and/or arrangement relationships between components illustrated in FIG. 12 may be included alone or in combination with the features, components, and arrangement relationships between components described in other drawings of the disclosure. Likewise, all features, components, and/or arrangement relationships between components described in connection with FIGS. 1 to 11 and 13 may be included alone or in combination with the features, components, and arrangement relationships between components described in connection with FIG. 12.

Referring to FIG. 12, a first case 240 according to an embodiment may be injection-molded using a heat-generating resin composition. Here, the heat-generating resin composition may be manufactured using ABS resin as a base resin. The first case 240 may be configured to generate heat when power is applied to heat buffer cells 275, 375.

According to an embodiment, the first case 240 may raise the temperature around ice during the process of forming ice in order to suppress bubble generation in ice formed in a first tray (e.g., the first tray 270 of FIG. 4) and a second tray (e.g., the second tray 370 of FIG. 4). By heating the first case 240, dissolved gases remaining in water may be moved to the buffer cells 275, 375 and removed. By dissolved gases in ice-making cells 272, 372 being moved to the buffer cells 275, 375 and heated, ice formed in the ice-making cells 272, 372 may be formed as transparent ice with cloudiness removed.

According to an embodiment, the first case 240 may include 17 weight % to 40 weight % of carbon filler and 60 to 83 weight % of acrylonitrile butadiene styrene (ABS) resin. The carbon filler may include at least one of carbon fiber, carbon nano tubes, carbon black, and graphene. The composition included in the heat-generating resin composition may include, with respect to 100 weight % of carbon filler, 85 weight % to 97 weight % of carbon filler, 1 weight % to 5 weight % of carbon black, 1 weight % to 5 weight % of carbon nano tubes, and 1 weight % to 5 weight % of graphene.

According to an embodiment, the first case 240 may include a case body 241 and a pair of electrode portions 242, 243. The pair of electrode portions 242, 243 may extend from the case body 241. The pair of electrode portions 242, 243 may extend from edge portions of the case body 241, but the disclosure is not limited thereto. The first case 240 may generate heat when voltage is applied through the pair of electrode portions 242, 243.

Although FIG. 10 illustrates the first case 240 as an example, it is not limited thereto, and a second case 340 may likewise be injection-molded using a heat-generating resin composition.

According to an embodiment, the ‘heat-generating resin composition’ mentioned in FIG. 12 may be substantially the same as the heat-generating resin composition described with reference to FIGS. 5 to 8. The composition of the ‘heat-generating resin composition’ in FIG. 12 may be substantially the same as the composition of the heat-generating resin composition described with reference to FIGS. 5 to 8.

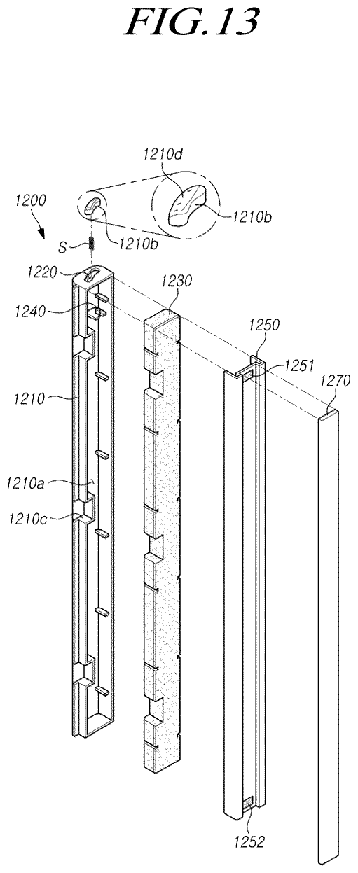

FIG. 13 is an exploded perspective view illustrating a rotating bar of a refrigerator according to an embodiment.

All features, components, and/or arrangement relationships between components illustrated in FIG. 13 may be included alone or in combination with the features, components, and arrangement relationships between components described in other drawings of the disclosure. Likewise, all features, components, and/or arrangement relationships between components described in connection with FIGS. 1 to 12 may be included alone or in combination with the features, components, and arrangement relationships between components described in connection with FIG. 13.

Referring to FIG. 13, a refrigerator (e.g., the refrigerator 100 of FIG. 1) may include a rotating bar 1200 (e.g., the rotating bar 1316 of FIG. 1). The refrigerator 100 may include a pair of first doors (e.g., the first door 131 of FIG. 1). The rotating bar 1200 may be rotatably coupled to one first door 131. The rotating bar 1200 may be disposed between the pair of first doors 131 to prevent or reduce cold air leakage. When the pair of first doors 131 close a storage compartment (e.g., the storage compartment 120 of FIG. 1), cold air may leak to the outside through gaps formed between the pair of first doors 131. The rotating bar 1200 may be provided to block such gaps.

According to an embodiment, the rotating bar 1200 includes a case 1210 that forms an exterior and has a receiving space 1210a inside with one side open, an insulation member 1230 received in the receiving space 1210a of the case 1210, a rotating bar cover 1250 coupled to the open side of the case 1210, a metal plate 1270 coupled to the outside of the rotating bar cover 1250, and a heat-generating member disposed in the space between the rotating bar cover 1250 and the metal plate 1270.

According to an embodiment, a guide protrusion 1210b is provided at the upper portion of the case 1210, which guides the rotating bar 1200 to rotate.

According to an embodiment, a through portion 1240 may be provided at the upper portion of the case 1210 so that the guide protrusion 1210b may protrude to the outside of the case 1210, and the through portion 1240 may be formed as a hole having the same shape as the guide protrusion 1210b.

According to an embodiment, an inclined side 1210d is provided on one side of the guide protrusion 1210b, and a spring S having elasticity is provided at the lower portion of the guide protrusion 1210b.

According to an embodiment, the upper portion of the spring S is coupled to the guide protrusion 1210b, and the lower portion of the spring S is coupled to a coupling protrusion so that the guide protrusion 1210b may be moved in the upper and lower directions in the through portion 1240 by the elastic force of the spring S.

According to an embodiment, the rotating bar 1200 is rotatably coupled to the first door 131 by a hinge bracket (not illustrated), and a plurality of coupling portions 1210c to which the hinge bracket is rotatably coupled may be formed in the case 1210.

According to an embodiment, the insulation member 1230 is for insulating a storage compartment (e.g., the storage compartment 120 of FIG. 1), and may be formed of expanded polystyrene (EPS) material that has excellent insulation performance and is lightweight.

According to an embodiment, the insulation member 1230 may be formed to have a shape that may be substantially inserted into the receiving space 1210a of the case 1210, and then inserted into the receiving space 1210a of the case 1210.

According to an embodiment, the rotating bar cover 1250 covers the open side of the case 1210, and may be coupled to the open side of the case 1210 after the insulation member 1230 is inserted into the receiving space 1210a of the case 1210.

According to an embodiment, a metal plate 1270 formed of metal material may be coupled to the outside of the rotating bar cover 1250 to tightly contact a gasket by magnetic force of a magnet (not illustrated) included in the gasket and provide rigidity to the rotating bar 1200.

According to an embodiment, the rotating bar cover 1250 may include an injection-molded product composed of a heat-generating resin composition. Here, the heat-generating resin composition may be the resin composition described with reference to FIGS. 5 to 8. According to an embodiment, the heat-generating resin composition may include 17 weight % to 40 weight % of carbon filler and 60 to 83 weight % of acrylonitrile butadiene styrene (ABS) resin. The carbon filler may include at least one of carbon fiber, carbon nano tubes, carbon black, and graphene. The composition included in the heat-generating resin composition may include, with respect to 100 weight % of carbon filler, 85 weight % to 97 weight % of carbon filler, 1 weight % to 5 weight % of carbon black, 1 weight % to 5 weight % of carbon nano tubes, and 1 weight % to 5 weight % of graphene.

According to an embodiment, the rotating bar cover 1250 may be composed of a heat-generating resin composition. The rotating bar cover 1250 may be injection-molded using a resin composition that generates heat in response to an applied voltage and has a very low electrical resistance reduction rate even with repeated use, as described with reference to FIGS. 5 to 8.

According to an embodiment, the rotating bar cover 1250 may include a first rotating bar electrode portion 1251 and a second rotating bar electrode portion 1252. The rotating bar cover 1250 may receive voltage from the first rotating bar electrode portion 1251 and the second rotating bar electrode portion 1252 to generate heat.

According to an embodiment, the rotating bar 1200 is a portion that directly contacts cold air inside the storage compartment 120, and condensation may occur on the surface of the rotating bar 1200 due to the temperature difference between the storage compartment 120 and the outside of the refrigerator 100. To prevent or reduce condensation, a separate heating device is generally provided in the rotating bar 1200. Since the heating device should be directly assembled by workers during the assembly process, defects may occur during the assembly process. The rotating bar 1200 according to an embodiment of the disclosure may be manufactured using a resin composition capable of generating heat and sustainable use, thereby obviating the need for a separate heating device. As a result, manufacturing costs may be decreased, and the defect occurrence rate due to worker skill level may also be decreased.

With the above-described configuration, when the pair of first doors 131 are closed, the rotating bar 1200 tightly contacts the gasket of the first door 131 to seal the gap between the pair of first doors 131, while minimizing heat generated from the rotating bar cover 1250 of the rotating bar 1200 from penetrating into the storage compartment 120.

Therefore, not only is the insulation performance of the rotating bar 1200 enhanced, but also heat loss of heat generated from the rotating bar cover 1250 is minimized, so energy for preventing or reducing frost formation on the rotating bar 1200 may be saved.

According to an embodiment, a resin composition configured to generate heat by electrical resistance when voltage is applied may include 17 weight % to 40 weight % of carbon filler and 60 to 83 weight % of acrylonitrile butadiene styrene (ABS) resin.

According to an embodiment, the carbon filler may include at least one of carbon fiber (CF), carbon nano tube (CNT), carbon black (CB), and graphene.

According to an embodiment, the carbon fiber may be 85 weight % to 97 weight % with respect to 100 weight % of the carbon filler.

According to an embodiment, the carbon black may be 1 weight % to 5 weight % with respect to 100 weight % of the carbon filler.

According to an embodiment, the carbon nano tube may be 1 weight % to 5 weight % with respect to 100 weight % of the carbon filler.

According to an embodiment, the graphene may be 1 weight % to 5 weight % with respect to 100 weight % of the carbon filler.

According to an embodiment, the resin composition may have a resistance reduction rate of 1% or less when voltage application and voltage non-application are repeated 200 times or more at predetermined time intervals.

According to an embodiment, the carbon filler may be irregularly disposed without directionality.

A refrigerator 100 according to an embodiment may include a main body 110 including a storage compartment 120, an ice-making assembly 200 disposed inside the storage compartment 120, and a water supply member 150 configured to supply water from an external water source to the ice-making assembly 200. At least some components of the ice-making assembly 200 may be composed of a heat-generating resin composition that generates heat by electrical supply. The heat-generating resin composition may include 17 to 40 weight % of a carbon filler and 60 to 83 weight % of an acrylonitrile butadiene styrene (ABS) resin.

According to an embodiment, the ice-making assembly may have at least some components composed of the heat-generating resin composition among components directly contacting water or ice.

According to an embodiment, the ice-making assembly 200 may include a first case 240 and a second case 340 disposed to face each other, a first tray 270 received in the first case 240 and forming a first portion of ice, and a second tray 370 received in the second case 340 and forming a second portion of the ice. At least one of the first case 240, the second case 340, the first tray 270, and the second tray 370 may be composed of the heat-generating resin composition.

According to an embodiment, at least one of the first case 240, the second case 340, the first tray 270, and the second tray 370 composed of the heat-generating resin composition may further include a pair of electrode portions for receiving power.

According to an embodiment, the ice-making assembly 200 may further include a first electrode portion extending from the inlet portion 230 and a second electrode portion extending from the first component.

According to an embodiment, the refrigerator 100 may further include a pair of first doors 131 rotatably connected to the main body to open and close the storage compartment 120, and a rotating bar 1200 rotatably coupled to one of the pair of first doors 131 and disposed between the pair of first doors 131 configured to prevent or to reduce cold air leakage from the storage compartment 120. A portion of the rotating bar 1200 may be composed of the heat-generating resin composition.

According to an embodiment, the carbon filler may include at least one of carbon fiber (CF), carbon nano tube (CNT), carbon black (CB), and graphene.

According to an embodiment, the carbon fiber may be 85 weight % to 97 weight % with respect to 100 weight % of the carbon filler.

According to an embodiment, the carbon black may be 1 weight % to 5 weight % with respect to 100 weight % of the carbon filler. The carbon nano tube may be 1 weight % to 5 weight % with respect to 100 weight % of the carbon filler. The graphene may be 1 weight % to 5 weight % with respect to 100 weight % of the carbon filler.

According to an embodiment, the carbon filler may be irregularly disposed without directionality.

The terms as used herein are provided merely to describe some embodiments thereof, but are not intended to limit the disclosure. As used herein, the singular forms “a,” “an,” and “the” are intended to include the plural forms as well, unless the context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, the term ‘and/or’ should be understood as encompassing any and all possible combinations by one or more of the enumerated items. As used herein, the terms “include,” “have,” and “comprise” are used merely to designate the presence of the feature, component, part, or a combination thereof described herein, but use of the term does not exclude the likelihood of presence or adding one or more other features, components, parts, or combinations thereof. As used herein, the terms “first” and “second” may modify various components regardless of importance and/or order and are used to distinguish a component from another without limiting the components.

As used herein, the terms “configured to” may be interchangeably used with the terms “suitable for,” “having the capacity to,” “designed to,” “adapted to,” “made to,” or “capable of” depending on circumstances. The term “configured to” does not essentially mean “specifically designed in hardware to.” Rather, the term “configured to” may mean that a device can perform an operation together with another device or parts. For example, a ‘device configured (or set) to perform A, B, and C’ may be a dedicated device to perform the corresponding operation or may mean a general-purpose device capable of various operations including the corresponding operation.

Meanwhile, the terms “upper side”, “lower side”, and “front and rear directions” used in the disclosure are defined with respect to the drawings, and the shape and position of each component are not limited by these terms.

In the disclosure, the above-described description has been made mainly of specific embodiments, but the disclosure is not limited to such specific embodiments, but should rather be appreciated as covering all various modifications, equivalents, and/or substitutes of various embodiments.

1. A resin composition comprising:
17 to 40 weight % of a carbon filler; and
a remainder of an acrylonitrile butadiene styrene resin,
wherein, in response to a voltage being applied to the resin composition, heat is generated by an electrical resistance of the resin composition.

2. The resin composition of claim 1, wherein the carbon filler includes carbon fiber, carbon nano tubes, carbon black, graphene, or a combination thereof.

3. The resin composition of claim 2, wherein the carbon filler has a composition of 85 weight % to 97 weight % of the carbon fiber with respect to a total weight of the carbon filler.

4. The resin composition of claim 2, wherein the carbon filler has a composition of 1 weight % to 5 weight % of the carbon black with respect to a total weight of the carbon filler.

5. The resin composition of claim 2, wherein the carbon filler has a composition of 1 weight % to 5 weight % of the carbon nano tubes with respect to a total weight of the carbon filler.

6. The resin composition of claim 2, wherein the carbon filler has a composition of 1 weight % to 5 weight % of the graphene with respect to a total weight of the carbon filler.

7. The resin composition of claim 1, wherein with the voltage repeatedly being applied to, and withdrawn from, the resin composition 200 times or more during respectively corresponding time intervals, a resistance reduction rate of the resin composition is 1% or less.

8. The resin composition of claim 1, wherein the carbon filler is irregularly arranged in the resin composition without directionality.

9. A refrigerator comprising:
a main body including a storage compartment;
an ice-making assembly inside the storage compartment and configured to make ice from water; and
a water supply member configured to supply the water to be made into the ice from an external water source to the ice-making assembly,
wherein at least a portion of the ice-making assembly includes a resin composition including:
17 to 40 weight % of a carbon filler, and
a remainder of an acrylonitrile butadiene styrene resin, and
in response to a voltage being applied to the resin composition, heat is generated by an electrical resistance of the resin composition.

10. The refrigerator of claim 9, wherein one or more components of the ice-making assembly, that are configured to directly contact water or ice during operation of the ice-making assembly, include the resin composition.

11. The refrigerator of claim 9, wherein
the ice-making assembly includes:
a first case including a first tray configured to form a first portion of ice made by the ice-making assembly, and
a second case that faces the first case, and including a second tray configured to form a second portion of the ice made by the ice-making assembly, and
at least one of the first case, the second case, the first tray, and the second tray includes the resin composition.

12. The refrigerator of claim 11, wherein the at least one of the first case, the second case, the first tray, and the second tray further includes a pair of electrode portions configured to receive power so as to apply the voltage to the resin composition.

13. The refrigerator of claim 9, wherein
the ice-making assembly includes:
a cover housing, and
an inlet portion including the resin composition, and configured to guide water supplied from the water supply member to an inside of the cover housing.

14. The refrigerator of claim 13, wherein
the inlet portion and a first component of the ice-making assembly are integrally formed, and
the inlet portion and the first component each include the resin composition.

15. The refrigerator of claim 14, wherein
the inlet portion includes a first electrode portion,
the first component includes a second electrode portion, and
the first electrode portion and the second electrode portion are configured to receive power so as to apply the voltage to the resin composition.

16. The refrigerator of claim 9, further comprising:
a pair of doors connected to the main body and that are rotatable to open and close to respectively open and close the storage compartment; and
a rotating bar coupled to, and rotatable with respect to, one door of the pair of doors, the rotating bar between the pair of doors and configured to prevent cold air leakage from the storage compartment,
wherein a portion of the rotating bar includes the resin composition.

17. The refrigerator of claim 9, wherein the carbon filler includes carbon fiber, carbon nano tubes, carbon black, graphene, or a combination thereof.

18. The refrigerator of claim 17, wherein the carbon filler has a composition of 85 weight % to 97 weight % of the carbon fiber with respect to a total weight of the carbon filler.

19. The refrigerator of claim 17, wherein
the carbon filler has a composition including:
1 weight % to 5 weight % of the carbon black with respect to a total weight of the carbon filler,
1 weight % to 5 weight % of the carbon nano tubes with respect to the total weight of the carbon filler, and
1 weight % to 5 weight % of the graphene with respect to the total weight of the carbon filler.

20. The refrigerator of claim 9, wherein the carbon filler is irregularly arranged in the resin composition without directionality.
